(19) United States
(12) Patent Application Publication
(10) Pub. No.: US 2012/0042288 A1
(43) Pub. Date: Feb. 16, 2012

(54) SYSTEMS AND METHODS FOR INTERACTIONS WITH DOCUMENTS ACROSS PAPER AND COMPUTERS

(75) Inventors: Chunyuan LIAO, Mountain View, CA (US); Hao Tang, Champaign, IL (US); Qiong Liu, Milpitas, CA (US); Patrick Chiu, Menlo Park, CA (US); Francine Chen, Menlo Park, CA (US)

(73) Assignee: FUJI XEROX CO., LTD., Minato-ku (JP)

(21) Appl. No.: 12/857,497

(22) Filed: Aug. 16, 2010

(51) Int. Cl. G06F 3/033; H04N 5/225

(52) U.S. Cl. 715/863; 348/207.1; 348/E05.024

(57) ABSTRACT

Systems and methods provide for mixed use of physical documents and a computer, and more specifically provide for detailed interactions with fine-grained content of physical documents that are integrated with operations on a computer to provide for improved user interactions between the physical documents and the computer. The system includes a camera which processes the physical documents and detects gestures made by a user with respect to the physical documents, a projector which provides visual feedback on the physical document, and a computer with a display to coordinate the interactions of the user with the computer and the interactions of the user with the physical document. The system, which can be portable, is capable of detecting interactions with fine-grained content of the physical document and translating interactions at the physical document with the computer display, and vice versa.

### BACKGROUND

1. Field of the Invention

This invention relates to systems and methods for interacting with physical documents and a computer, and more specifically to relating user interactions between a physical document and related content on a computer in a hybrid paper and computer-based interface.

2. Description of the Related Art

Paper and computers are the two most commonly used media for document processing. Paper is comfortable to read and annotate, light to carry, flexible to arrange in a space, robust to use in various settings, and well accepted in social settings. Computers are useful in multimedia presentations, document editing, archiving, sharing and search. Because of these unique and complementary advantages, paper and computers are extensively used in parallel in many scenarios. This situation will likely continue in the foreseeable future, due to the technical difficulties and cost-efficiency concerns about completely replacing paper with computers.

In a typical workstation setting, a user may desire simultaneous use of paper and computers, especially by using paper documents 112 and a computer 106 side by side on a table, as shown in FIG. 1. People often use this setting to, for example, read an article on a physical piece of paper and write a summary on the computer. In conjunction with the read-write activities, users often need to search the Internet for extra information about specific content, quote a sentence or copy a diagram from the article, or share interesting sections of an article with friends via email or instant messaging (“IM”).

The problem, however, is that the existing technology for mixed use of paper and computers does not provide for convenient transition or interaction between the two media. The content on paper is insulated from computer-based digital tools such as remote sharing, hyperlinks, copy-paste, Internet searching and keyword finding. This gap between paper and computers results in low efficiency and degraded user experience when using paper in combination with a computer. For example, it is tedious for business people to manually transcribe paper receipts for reimbursement, and for accountants to compare the reimbursement form and the original receipts for verification. In another example, it is nearly impossible for a person to search the Internet for an unknown foreign word in a book if he/she does not know how to type in that language. Similarly, it is inconvenient to copy a picture from a paper document to a digital document on a computer.

Efforts have been made to address the paper-computer boundaries, but the work still does not bridge the gap. First, most of the current systems such as PlayAnywhere (Wilson, A. D., PlayAnywhere: a compact interactive tabletop projection-vision system, Proceedings of UIST '05, pp. 83-92), DocuDesk (Everitt, K. M., M. R. Morris, A. J. B. Brush, and A. D. Wilson, DocuDesk: an interactive surface for creating and rehydrating many-to-many linkages among paper and digital documents, Proceedings of IEEE TABLETOP '08, pp. 25-28) and Bonfire (Kane, S. K., D. Avrahami, J. O. Wobbrock, B. Harrison, A. D. Rea, M. Philipose, and A. LaMarca, Bonfire: a nomadic system for hybrid laptop-tabletop interaction, Proceedings of UIST '09, pp. 129-138) focus on interaction with a whole page or document, and do not support fine-grained manipulation within the document (e.g. individual words, symbols and arbitrary regions). Second, those systems only support limited digital functions on paper, typically page-level hyperlinks (PlayAnywhere, DocuDesk), spatial arrangement tracking (Kim, J., S. M. Seitz, and M. Agrawala, Video-based document tracking: unifying your physical and electronic desktops, Proceedings of UIST '04, pp. 99-107), and text transcribing (Newman, W., C. Dance, A. Taylor, S. Taylor, M. Taylor, and T. Aldhous, CamWorks: A Video-based Tool for Efficient Capture from Paper Source Documents, Proceedings of IEEE Multimedia System '99, pp. 647-653; and Wellner, P., Interacting with paper on the DigitalDesk, Communications of the ACM, 1993. 36(7): pp. 87-96), which are not enough to address the above issues. Third, they may interfere with the existing workflow, due to their inflexible hardware configuration and the requirement in some for specially marked paper (Song, H., Guimbretiere, F., Grossman, T., and Fitzmaurice, G., MouseLight: Bimanual Interactions on Digital Paper Using a Pen and a Spatially-aware Mobile Projector, Proceedings of CHI '10).

As described above, current systems for relating paper documents to activities on a computer suffer from numerous limitations, and as such, there is a need for improvements to the ability to work with physical documents and computers at the same time.

### SUMMARY

Systems and methods described herein provide for interacting with physical documents and at least one computer, and more specifically to providing detailed interactions with fine-grained content of physical documents that is integrated with operations on at least one computer to provide for improved user interactions between the physical documents and the computer.

In one aspect of the invention, a system for interacting with physical documents and at least one computer comprises a camera processing module which processes the content of at least one physical document and detects user interactions on the at least one physical document; a projector processing module which provides visual feedback on the at least one physical document; and a computer with a screen which coordinates the user interactions on the at least one physical document with an action on the computer.

In another aspect of the invention, the camera processing module processes fine-grained content of the at least one physical document, including individual words, characters and graphics, and detects user interactions relating to the fine-grained content.

In another aspect of the invention, the visual feedback provided by the projector processing module is based on user interactions on the physical document.

In another aspect of the invention, the user interactions further include gestures made on the at least one physical document which correspond to actions on the computer.

In another aspect of the invention, the gestures correspond to pre-configured commands which result in a specific type of visual feedback.

In another aspect of the invention, a user interaction on the computer is translated into visual feedback provided by the projector processing module to the at least one physical document.

In another aspect of the invention, the projector processing module provides visual feedback on a physical surface other than the physical document.

In another aspect of the invention, the system further comprises a portable, integrated camera and projector with a foldable frame and at least one mirror, the mirror attached to the frame and positioned over the at least one physical document to reflect an optical path of the camera and projector onto the at least one physical document.

In another aspect of the invention, the camera processing module processes the content of the at least one physical document and obtains a corresponding digital document to display on the computer screen.

In another aspect of the invention, the user interactions on the at least one physical document result in corresponding interactions on the corresponding digital document.

In another aspect of the invention, the camera processing module processes the content of the at least one physical document and obtains digital content which relates to the at least one physical document.

In another aspect of the invention, a method for interacting with at least one physical document and at least one computer comprises processing the at least one physical document; detecting user interactions with the at least one physical document; providing visual feedback on the at least one physical document; and coordinating the user interactions on the at least one physical document with interactions on a computer with a screen.

In another aspect of the invention, the method further comprises processing the at least one physical document to identify fine-grained content, including individual words, characters and graphics; and detecting user interactions relating to the fine-grained content.

In another aspect of the invention, the visual feedback is based on user interactions on the physical document.

In another aspect of the invention, the user interactions further include gestures made on the at least one physical document which correspond to actions on the computer.

In another aspect of the invention, the gestures correspond to pre-configured commands which result in a specific type of visual feedback.

In another aspect of the invention, the method further comprises providing visual feedback on a physical surface other than the physical document.

In another aspect of the invention, the method further comprises translating a user interaction on the computer into visual feedback on the at least one physical document.

In another aspect of the invention, the method further comprises translating user interaction with the at least one physical document with simultaneous user interaction on the computer to manipulate detailed content of the at least one physical document.

In another aspect of the invention, the detailed content of the physical document is manipulated by user interactions using a first hand to interact with the at least one physical document and a second hand to interact with the computer.

In another aspect of the invention, the detailed content of the digital document is manipulated by user interactions using a first hand to interact with the at least one physical document and a second hand to interact with the computer.

In another aspect of the invention, the method further comprises synchronously manipulating detailed content of the physical document and a digital document on the computer using a first hand to interact with the at least one physical document and a second hand to interact with the digital document.

In another aspect of the invention, the method further comprises processing the content of the at least one physical document and obtaining a corresponding digital document to display on the computer screen.

In another aspect of the invention, the user interactions on the at least one physical document result in corresponding interactions on the corresponding digital document.

In another aspect of the invention, the method further comprises processing the content of the at least one physical document and obtaining digital content which relates to the at least one physical document.

In still another aspect of the invention, a computer program product for interacting with at least one physical document and a computer is embodied on a computer readable storage medium, and, when executed by a computer, performs the method comprising processing the at least one physical document; detecting user interactions with the at least one physical document; providing visual feedback on the at least one physical document; and coordinating the user interactions on the at least one physical document with interactions on a computer with a screen.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a workstation setting including a laptop computer with a screen next to a notebook with paper documents, as is known in the art;

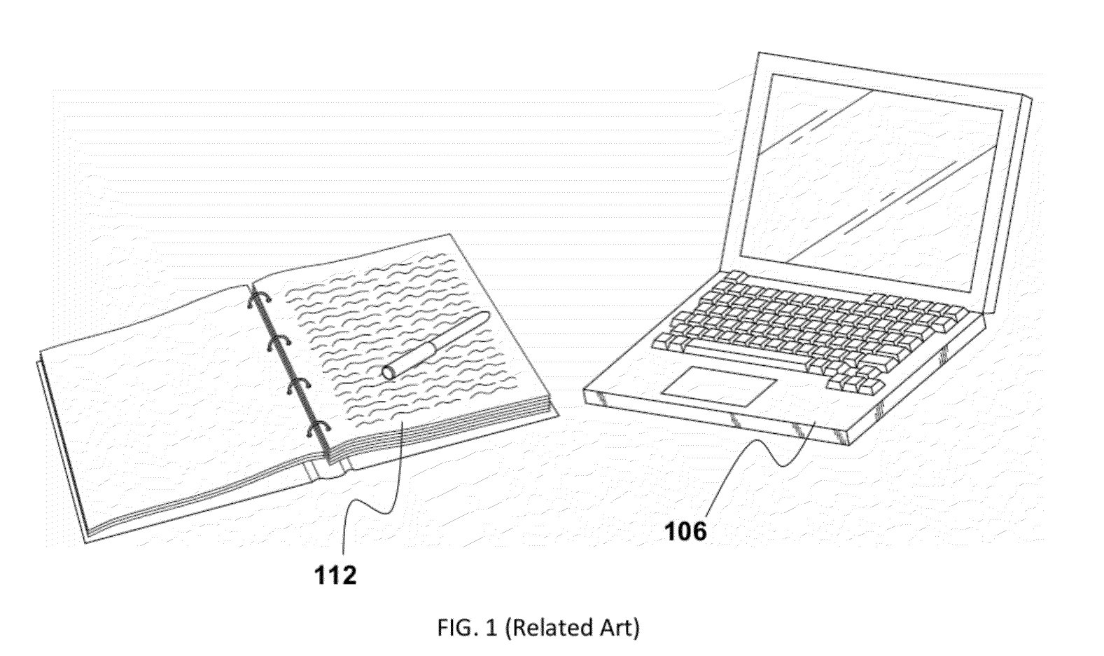

FIG. 2 illustrates a system of interacting with a physical document and a digital document using a camera, projector and computer with a screen, according to one embodiment of the invention;

FIG. 3 illustrates workspace where a user is able to simultaneously interact with a paper map and a computer displaying an image related to a position selected by the user's finger on the map, according to one embodiment of the invention;

FIG. 4 illustrates a method of interacting with at least one physical document and a computer, according to one embodiment of the invention;

FIG. 5 illustrates a portable camera-projector unit including at least one mirror connected to a foldable frame, according to one embodiment of the invention;

FIG. 6 illustrates a system for digital-printout mapping, as is known in the art;

FIG. 7 is an illustration of a method for establishing a homographic transform between a camera reference frame and a recognized document reference frame, according to one aspect of the invention;

FIG. 8 illustrates a data flow of a method for interacting with a physical document, according to one embodiment of the invention;

FIGS. 9A-9H are a collection of illustrations of gestures which can be made by the user on the paper to select words, symbols and other document content, according to one embodiment of the invention;

FIG. 10 is an illustration of feedback from the projector highlighting the outer contour of selected content;

FIGS. 11A-11D are illustrations of a method of adaptive menu placement projection onto a physical document, according to one embodiment of the invention;

FIG. 12 is an illustration of a digital-proxy method of controlling a physical document on a computer, according to one embodiment of the invention;

FIG. 13 is an illustration of two-handed coordination between manipulation of the physical document with a first hand and manipulation of the computer with a second hand, according to one embodiment of the invention;

FIGS. 14A-14C are illustrations of two-handed interaction with the physical document, wherein a computer input device controlled by the second hand contributes to manipulation of the physical document by the first hand, according to one embodiment of the invention;

FIG. 15 is an illustration of two-handed interaction with the computer screen, wherein the movement of the first hand on the physical document contributes to manipulation of the computer screen by the second hand, according to one embodiment of the invention;

FIGS. 16A-16F are illustrations of an application of the inventive system to process information on a paper receipt, according to one embodiment of the invention;

FIGS. 17A-17C are illustrations of a keyword finding application of the inventive system, according to one embodiment of the invention;

FIGS. 18A-18C are illustrations of a map navigation application of the inventive system, according to one embodiment of the invention; and

FIG. 19 is a block diagram of a computer system upon which the system may be implemented, according to one embodiment of the invention.

### DETAILED DESCRIPTION

In the following detailed description, reference will be made to the accompanying drawings. The aforementioned accompanying drawings show by way of illustration and not by way of limitation, specific embodiments and implementations consistent with principles of the present invention. These implementations are described in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of specialized hardware, or combination of software and hardware.

Embodiments of the invention disclosed herein provide for interacting with physical documents and a computer, and more specifically to providing detailed interactions with fine-grained content of physical documents that is integrated with operations on a computer to provide for improved user interactions between the physical documents and the computer. Embodiments of the invention also support two-handed fine-grained interaction with physical documents and digital content using a hybrid camera-projector interface.

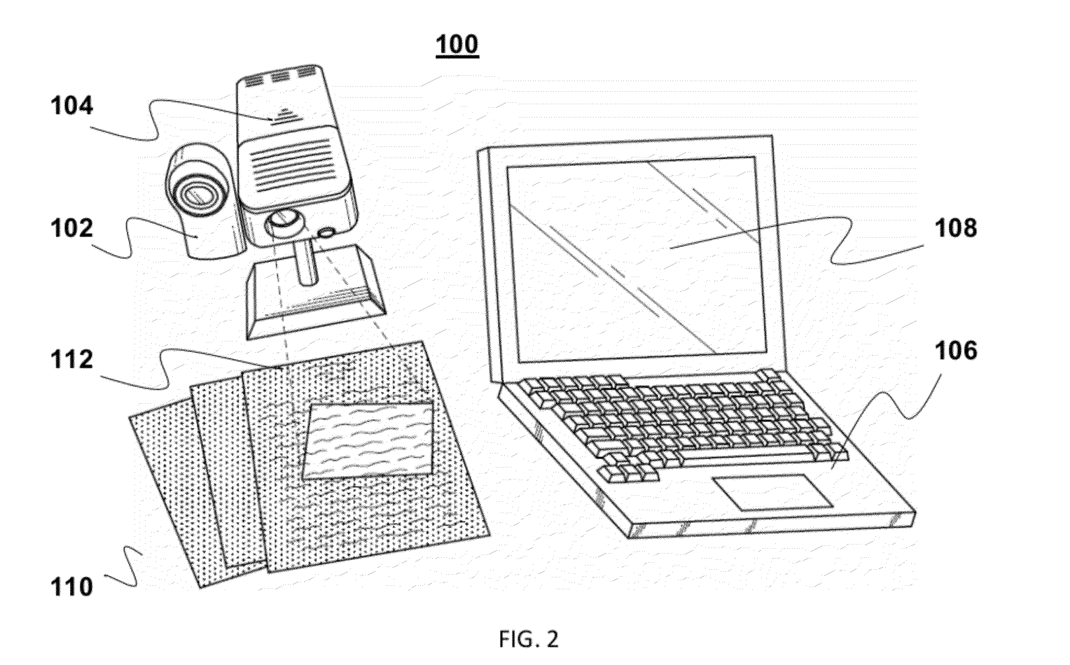

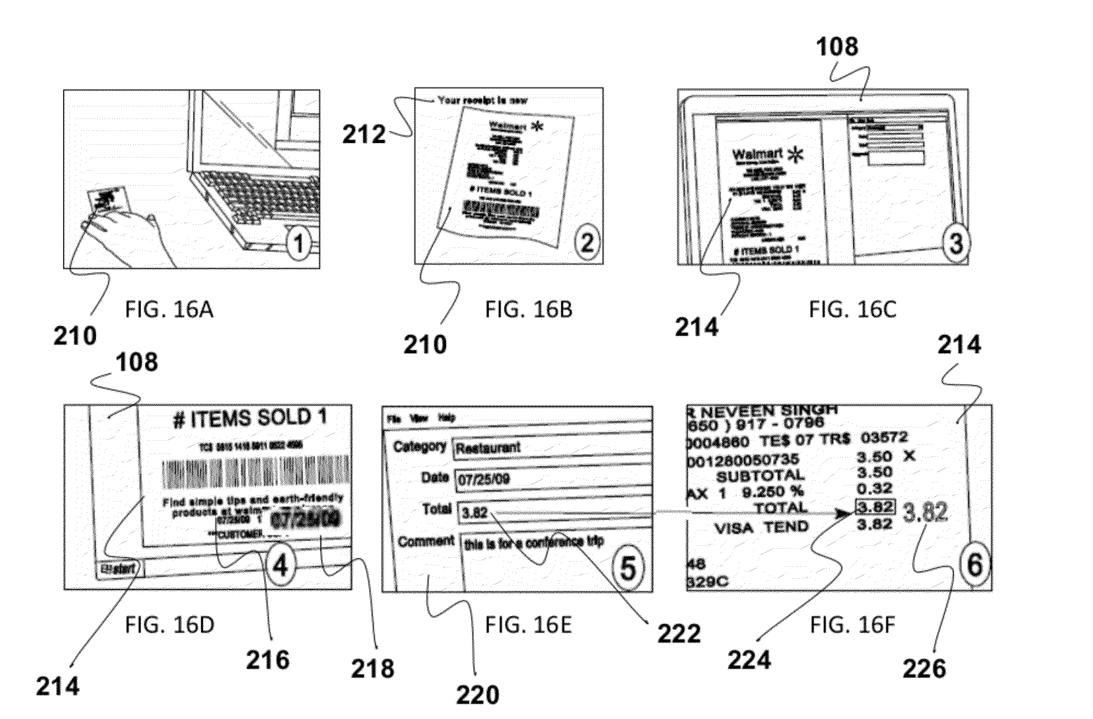

One embodiment of the system 100, illustrated in FIG. 2, comprises a camera 102, a projector 104 and a computer 106 with a screen 108. The camera 102 and projector 104 are positioned above a physical document workspace 110 where at least one physical document 112 may be placed, such as a piece of paper. In this framework, the camera 102 processes the physical document 112 and is capable of recognizing a user's finger and/or pen gestures. Specific operations are then performed based on the gestures. The projector 104 provides digital visual feedback directly onto the physical document 112 based on the gestures or other input from the computer 106. The computer 106 includes a processor and memory (see FIG. 16) and displays digital documents, web pages or other applications related to the physical documents on the screen 108. The computer 106 may also help translate visual input received by the camera 102 into appropriate feedback for the projector 104 or input to the computer 106 itself. The camera 102 and projector 104 may also comprise a processor and memory, and may also be capable of individually processing the input received by the camera 102 and translating the input into visual feedback at the projector 104.

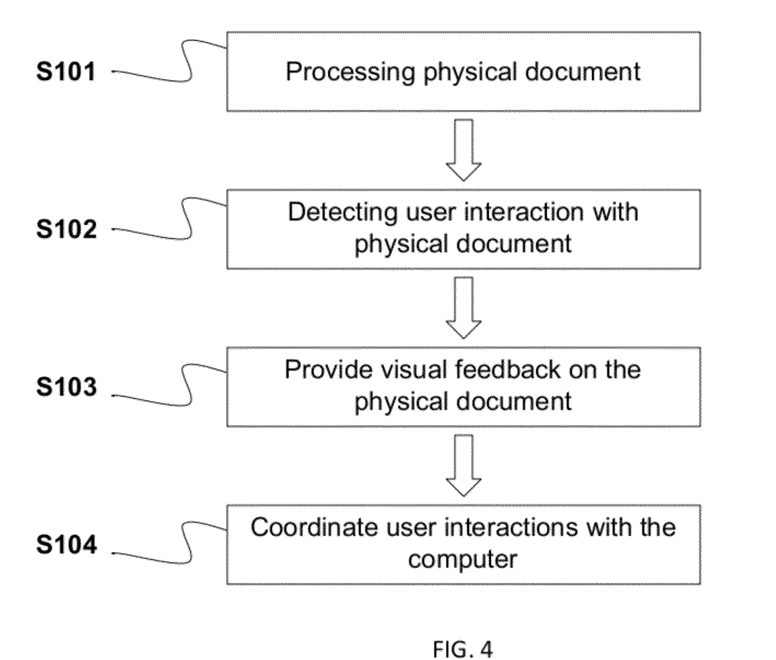

The camera and projector may be integrated into a single, portable camera-projector unit, as illustrated in FIG. 4, making the hardware system highly portable and flexible. If combined with a portable computer device, such as a laptop, tablet or cell phone, the entire system can be portable. The physical documents can be generic printed paper comprising text or graphics, all of which are completely compatible with the existing workflow.

The system provides for fine-grained interaction by allowing users to interact with the details of the physical document, including individual words, characters, symbols, icons and arbitrary regions specified by the users. The system additionally supports numerous computer functions on paper. For instance, the users can apply pen or finger gestures on the a paper document to copy and paste text and graphic content from the paper document to the computer, link a word on the physical document to a web page on the computer, search for specific keywords on the physical document or navigate a street level visual map on the computer by pointing to specific places on a paper map. All of these embodiments are detailed below.

Based on the fine-grained interaction with the physical document, the system supports cross-media two-handed interaction with the physical document and the computer, which combines the complementary affordances of paper and the computer. For instance, if camera-based user interaction with a physical document using a finger or pen is relatively coarse and unreliable, this interaction can be augmented with high fidelity and robust keyboard or mouse input on the computer. In another embodiment, the finger or pen input on the physical document can also be combined with mouse or keyboard input on the computer for multi-pointer operations on the computer. With this hybrid cross-media interaction, the system makes further advances in bridging the paper-computer boundary.

The framework of the system will now be further described, followed by more details of the components of the system. Further details of the interactions enabled by the framework as well as a demonstration of various applications will then be provided.

### I. System Overview

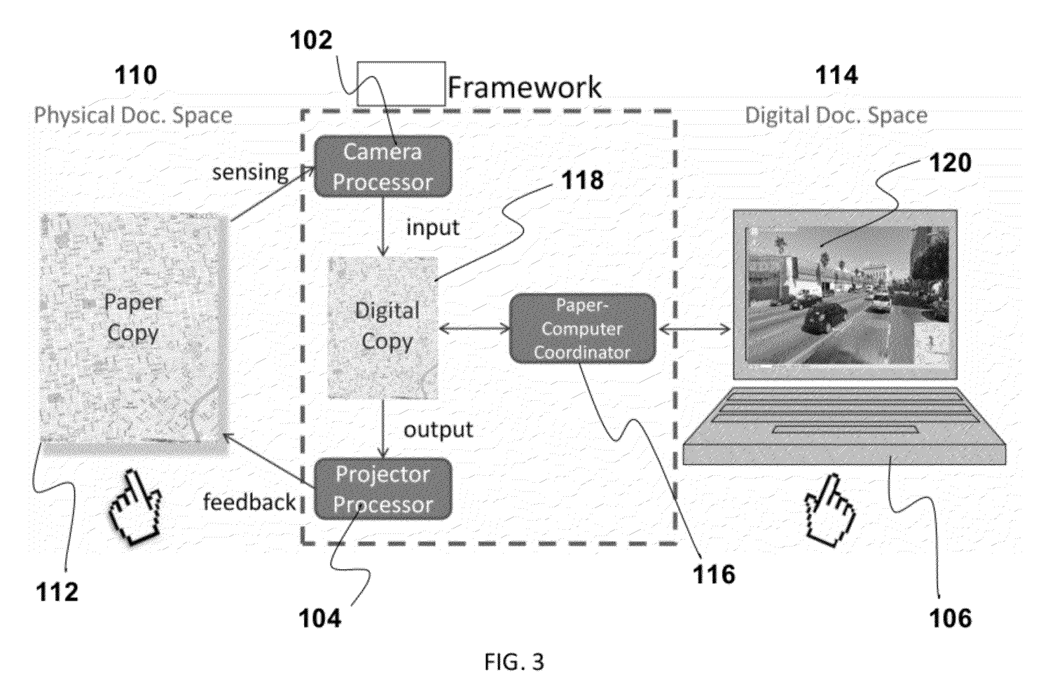

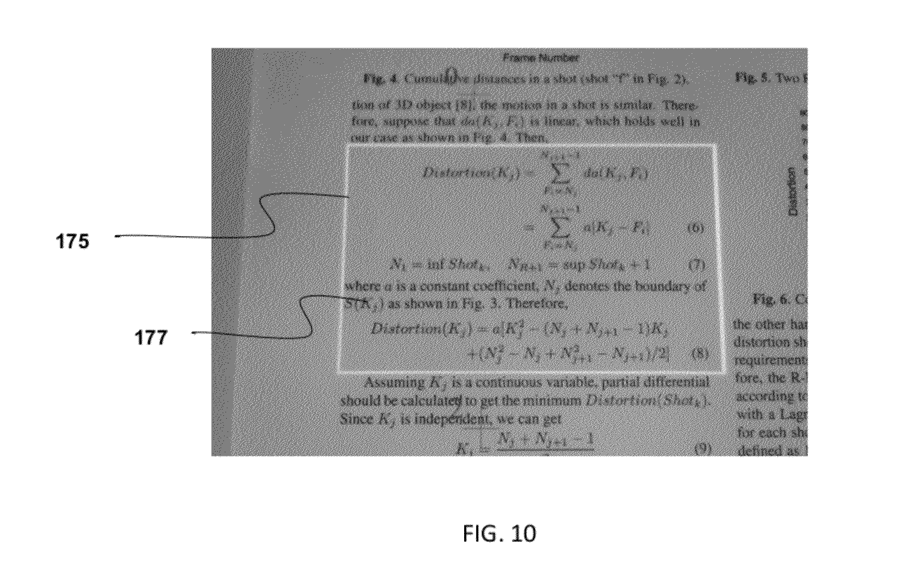

The system acts as a bridge between the physical document workspace 110 and a digital document workspace 114, as illustrated in FIG. 3. In one embodiment, the framework consists of three key components, namely a camera 102, projector 104 and paper-computer coordinating processor 116. In one embodiment, the camera includes a corresponding software module that processes the images captured by the camera device. Similarly, in one embodiment, the projector includes a corresponding processing software module. The camera 102 recognizes and tracks physical documents 112 (e.g. a printed map in FIG. 3) and detects and traces the position and movement of the user's finger tip or pen tip (see FIG. 10). As a result of the input from the camera, the projector 104 generates a projection image on the physical document 112 that is precisely aligned with the physical document content for direct visual feedback to the user. The camera 102 may also include a processor and memory which finds a digital version 118 of the recognized physical documents 112 on the computer. The camera 102 may also interpret the finger/pen tip operations as corresponding pointer manipulations on the digital version of the document being shown in the digital document workspace 112.

If needed, the paper-computer coordinating processor 116 coordinates actions in the physical document workspace 110 with the digital document workspace 114, manipulating the digital copy 118 or other content on the computer 106. In FIG. 3, the paper-computer coordinating processor 116 coordinates with the computer 106 to display a street view photograph 120 of a location selected by the user on the paper map 112 in the physical document workspace 110.

A method for interacting with the physical document and the computer is also described and illustrated in the block diagram in FIG. 4. In a first step S101, the system processes at least one physical document using the camera. In a second step S102, a user interaction with the physical document is detected, such as a finger tip or pen tip selection or gesture. The projector may then provide visual feedback on the physical document which corresponds to the user interaction, in step S103. In another step S104, the computer or another processor coordinates the user interactions with the computer, for example by manipulating a corresponding digital document or controlling another application related to the physical document.

The system described herein provides unique processing of generic document recognition, fine-grained document content location, precise projection correction and two-handed hybrid paper-computer input—all of which will be described in more detail below.

### II. The Portable User Interface Hardware

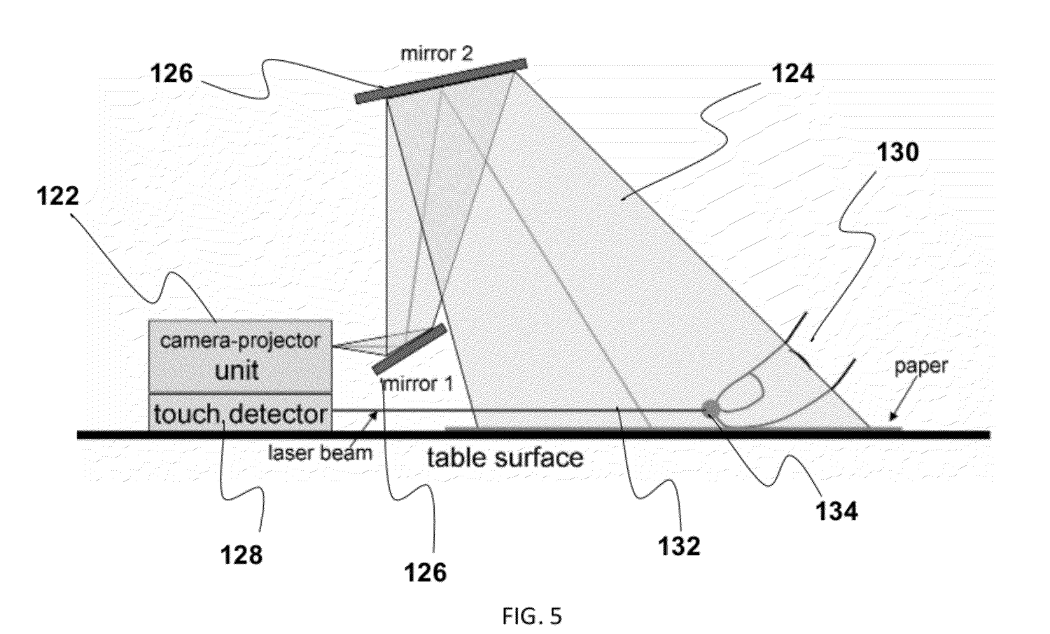

In one embodiment, the camera and projector may be integrated into a combined camera-projector unit 122, as shown in FIG. 4. Although described herein as a standalone unit connected to the computer 106 via, for example, a USB cable, the camera and projector could also be an embedded part of the computer 106. A standalone form factor gives more flexibility in the spatial arrangement of the components, physical workspace and digital workspace. The embodiment in FIG. 2 is only one possible framework, but other designs are also possible. As illustrated in FIG. 5, the camera-projector unit 122 can be installed horizontally at the bottom of the overall framework and workspace. An optical path 124 of the camera-projector unit 122 is extended by two mirrors 126 on a foldable frame (not shown), in order to cover a relatively large area of the physical desktop workspace 110 with only a compact form factor. This feature is important for a user in a mobile setting. In one embodiment, a touch detection module 128 can be installed at the bottom of the camera-projector unit 122 to detect the contact of fingers 130 or pen tips on the surface of the physical document workspace 110. In one current system, a very thin sheet of harmless diffused laser light 132 is spread just above the table, so that the finger 130 touching the surface of the physical document workspace 110 will result in a red-colored dot 134 in the video frames captured by the camera.

### III. Camera Processing Module

The camera processing module is responsible for recognizing the physical document, including the content, as well as tracking the movement of the document in order to adjust the visual output of the projector. The camera processing module also performs finger and pen tip detection and tracking as well as performing a coordinate system transform, which is described in more detail below. To be compatible with existing practices, a content-based document recognition algorithm is adopted to recognize paper documents in the camera view. In one embodiment, a color-based algorithm is employed to detect and track a bare finger or a pen tip as distinguished from the physical document. Based on this analysis, the finger or pen interaction with the physical document may be mapped to mouse-pointing operations on the corresponding digital version of the document being displayed on the computer screen. For real-time processing, the slow and accurate recognition algorithm is combined with a fast and relatively inaccurate inter-frame tracking algorithm. The relatively accurate recognition is performed upon user request or automatically at fixed intervals of time (e.g. 1˜2 seconds). Based on the result, the precise location of a paper document in a camera-captured video frame is estimated with the tracking result between two consecutive frames. Every recognition session resets the tracking module to reduce the accumulated error. The tracking algorithm could be based on optical flow or corner features of the camera images. In one embodiment, the algorithm used may be similar to that disclosed in “Video Puppetry: A Performative Interface for Cutout Animation, in ACM Transaction on Graphics, Vol. 27, No. 5, Article 124, 2008, by Barnes et al.,” although one of skill in the art will appreciate that other algorithms may be used for tracking the location and movement of the document.

### Physical Document Recognition

Embodiments of the system leverage a content-based document image recognition approach, identifying a normal generic printed document as is—without the need for barcodes or special digital paper. In this way, the system is completely compatible with existing document processing practices and provides for wide usability, as any type of document—from a newspaper to a receipt to a standard printout—can be used. Several algorithms may be used for document image recognition, but in this embodiment, we select a Fast Invariant Transform process, known as FIT, as described in Liu, Q., H. Yano, D. Kimber, C. Liao, and L. Wilcox; High Accuracy And Language Independent Document Retrieval With A Fast Invariant Transform; Proceedings of ICME '09, incorporated herein by reference in its entirety. FIT is a generic image feature descriptor, and is thus applicable to a wide range of document types (e.g. text, graphics and photos) and language-independent. FIT is also efficient in terms of search time and feature storage. FIT exploits local features at key points, being robust to partial occlusion, luminance change, scaling, rotations and perspective distortion.

In one embodiment of the system, when a user prints a document, a special instrumented printer drive intercepts the document and sends it to a server, which identifies feature points in every page and calculates a 40-dimension FIT feature vector for each point. The vectors are clustered into a tree for an ANN (Approximate Nearest Neighbor) correspondence search. Other metadata such as text, figures and hot spots in each document page are also extracted and indexed at the server. The same feature calculation is applied to a subsequent query image, and the resulting features are matched against those in the tree. If a feature point from the query image is similar (with some numeric similarity measurement) to a feature point from the index, the two points are matched and they are deemed to be “corresponded.” The page with the most matches (if above a threshold) is taken as the original digital page for the image.

### Pen Tip and Finger Tip Detection

In one embodiment, color-based methods track the tip of a finger or the tip of a pen based on the color of the finger or pen as contrasted with the background, which is typically the physical document itself. The color-based method assumes that the color of the finger and pen tip is distinguishable from the background. For finger tip detection, a fixed color model is adopted for skin color detection; for pen tip detection, a pre-captured pen-tip image for hue histogram back-projection is used. Additional methods may be used as well, as known to one of skill in the art.

To reduce the noise in the position of the detected point, Pt, a post-filter as applied to the Pt values and the Pt is only updated if the tip movement is above a threshold. Moreover, to avoid finger and pen occlusion, the idea of setting the projected cursor at a fixed distance above the detected tip may be used. Since there is a similarity in pen and finger tip processing, the pen-related techniques described below are applicable to finger interaction unless noted otherwise.

### Touch Detection

In the system described herein, there are many known solutions to realizing touch detection for pen and fingers. Known methods include approximating the finger to surface distance using the finger's shadow, and, as already described, spreading a thin sheet of diffused laser light just above the table for easily detecting objects close to the table.

### Mapping Physical Interaction to Digital Interaction at Fine Granularity

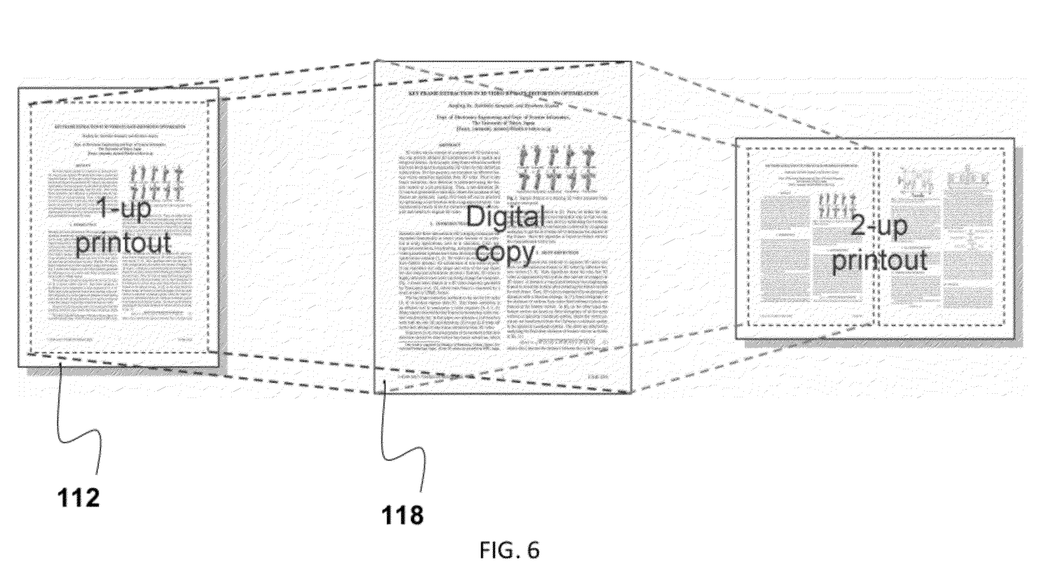

To interpret, at fine granularity, pen-paper interaction captured by the camera (e.g. pointing with a pen to a word on a paper document), a precise coordinate transform should be established from at least one camera image to at least one identical digital document page. This enables the accommodation of varying printing styles and spatial arrangement of paper sheets. Existing systems detect the boundary of a piece of paper and map the enclosed quadrangle to a rectangular digital image. This method is good enough for coarse granularity interaction, such as projecting a video onto a blank paper sheet. However, it is not accurate enough for word-level and symbol-level interaction, because the margin around the printout may lead to inaccurate mapping between the printed content 112 and the corresponding digital document page 118, as illustrated in FIG. 6. The margin may vary with different printers. N-up printing, where multiple digital pages are printed onto a side of a piece of paper, and overlapping pages exacerbate this situation, and these cases are quite common.

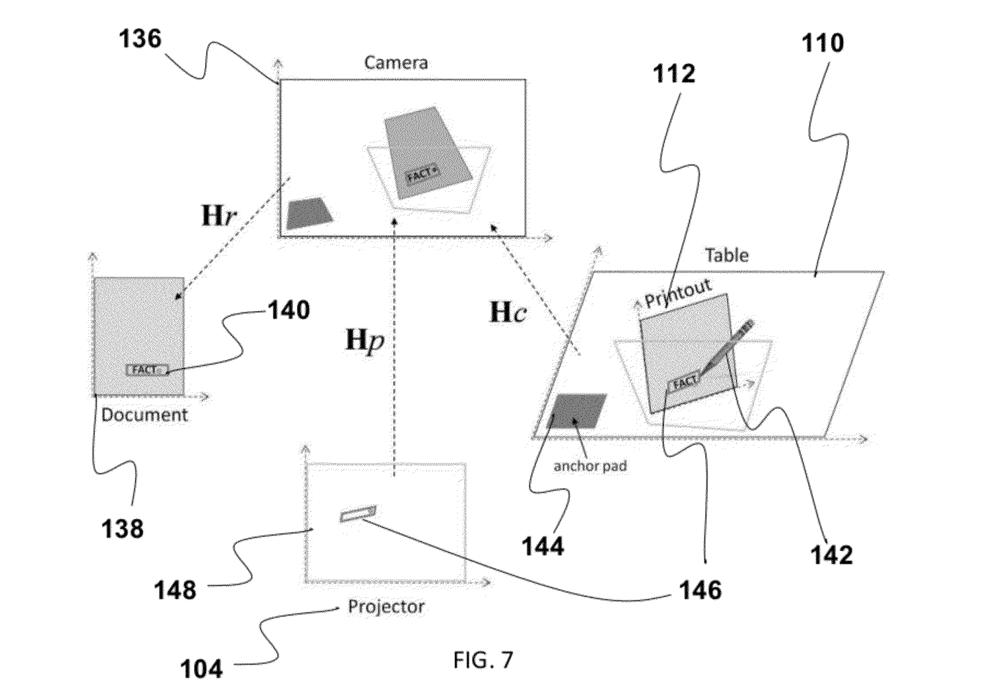

To address the limitations of the existing systems, we exploit the correspondence between the feature points in a camera image and those in the recognized digital document page to derive a homographic transform Hr between a camera reference frame 136 and a recognized digital document reference frame 138, as illustrated in FIG. 7. A transform matrix is derived from one-to-one feature point correspondence between a camera video frame 136 and the recognized digital document image 138. The recognized document image may be stored in a database on the computer. In one embodiment, at least four pairs of feature points are required. For N>4 pairs, a least-squares method may be used to find the best fitting transform matrix. To improve the mapping precision, an algorithm similar to RANSAC is applied to remove outliers, as described in Hare, J., P. Lewis, L. Gordon, and G. Hart; MapSnapper: Engineering an Efficient Algorithm for Matching Images of Maps from Mobile Phones; Proceedings of Multimedia Content Access '08: Algorithms and Systems II. With Hr, a finger tip or a pen tip detected in the camera video frame 136 is easily mapped to a point 140 in the coordinate system of the recognized digital document page 138. Based on this mapping, the finger/pen interactions 142 on the paper document 112 are translated into digital operations on the computer.

In one embodiment, to support interaction with arbitrary points on the physical document workspace in general, which may not necessarily be within a paper document, an anchor-pad 144 is utilized to define a table reference frame. The anchor-pad 144 may be a rectangular dark paper sheet of a known size, whose four corners define four points of fixed coordinates (e.g. (1,1), (1,2), (2,1) and (2,2)) in the table reference frame. During calibration, the camera detects the four corners of the anchor pad in its view, and derives a homographic transform Hc between the table, or physical document space 110, and the camera reference frames 136, as illustrated in FIG. 6. This assumes that the table surface 110 is always flat and thus the camera pose relative to the table is fixed, and therefore Hc is constant and needs to be calibrated only once.

### Semi-Real Time Processing

Supporting real-time interaction on paper may require an image processing speed of more than 15 frame-per-second (fps). However, the system described herein currently supports approximately 1 fps due to its high computational complexity. In contrast, document tracking techniques such as optical flow can estimate the relative movement of pages in real-time, but with accumulated errors. Optical flow is the pattern of apparent motion of objects, surfaces, and edges in a visual scene caused by the relative motion between an observer (an eye or a camera) and the scene. See Burton, Andrew and Radford, John; Thinking in Perspective: Critical Essays in the Study of Thought Processes; Routledge; 1978; ISBN 0416858406. The document recognition and document tracking can be combined for hybrid document tracking. In one embodiment, the system periodically recognizes a video frame and derives an Hr. Based on the result, Hr for subsequent video frames is estimated with the optical flow between two consecutive frames. Every recognition session resets the optical flow detection to reduce the accumulated error.

### IV. Projector Processor

The projector 104 enables dynamic visual feedback directly on the physical document 112 and physical document workspace 110. There are two basic projection types, namely local projection and global projection.

### Local Projection

With local projection, the projected image 146 is always aligned with the printout reference frame of a paper document 112 as illustrated in FIG. 7; however, the paper document may be moved during user interaction. Local projection is usually for overlaying information on top of specific paper document content, and must move along with the paper. One example is the projected bounding box 146 for highlighting the word “FACT” on the paper document 112 in FIG. 7.

The local projection usually results from pen-paper interaction, which is first mapped to a pointer operation in the corresponding digital document reference frame. The feedback information for the projector is thus defined directly in the same reference frame. For instance, as shown in FIG. 7, upon detecting a pen tip 142 pointed to a word “FACT” at location (5,5) in the document reference frame 110, the feedback generated is a rectangular box 146 of size 10 by 5 at location (5,5) in that reference frame. The challenge is to precisely map this box 146 to a projector reference frame 148 to generate the correct rectangular projection aligned with the word on the paper document 112.

The hardware settings are advantageous in establishing the mapping. The relative positions of the camera, projector and the table surface are fixed and the table is assumed to be flat, so a fixed homographic transform Hp exists between the camera reference frame 136 and the projector reference frame 148. As a result, the document-to-projector mapping can be described as Hp⁻¹*Hr⁻¹. In one embodiment, Hp is derived with a simple one-time calibration, where a pre-stored image with a known pattern is projected to the table surface and captured by the camera. By finding the feature correspondence between the projected and captured images (with N>=4 correspondence pairs), the Hp value is obtained.

The projection transform builds on the content-based camera-document transform. It varies for different document pages (multiple document pages could be recognized in one video frame) and different positions of a moving document in the camera view. The projection transform is also immune to the printing margin, N-up printing and partial occlusion. This immunity of projection transform is critical for precisely aligning the projected visual feedback 146 with the underlying paper document details.

### Global Projection

In contrast to local projection, global projection aligns the projection 146 with the table reference frame 110, and is not affected by paper movement. It is usually adopted for some global information that is not associated with a specific document page, such as the creation time of the whole document and the related references. It can be also used as a peripheral display to extend the computer display, for applications such as email notification, an instant message dashboard, or a system performance monitor.

The main issue of global projection is known as keystoning, where the projected image suffers from perspective distortion because of the misalignment of the projector's optical axis and the projection plane's normal, or direction perpendicular to the projection plane. In one embodiment, this can be corrected with reverse-distortion on the projected image 146. The key is to establish the coordinate transform from the projection plane 110 (i.e. the table) to the projector reference frame 148. As described above, the table-to-camera transform Hc and the projector-to-camera transform Hp is already known, so the table-to-projector homographic transform can be derived from Hp⁻¹*Hc.

### V. Fine-Grained Interaction on Paper

Based on the underlying camera-projector input/output component, embodiments of the system provide interaction techniques for fine-grained document content manipulation on paper to achieve a computer-equivalent user experience without sacrificing the flexibility and advantages of the paper document. In one embodiment, it is possible to provide cross-media two-handed interaction by mixing the camera input from a first hand in the physical document space with keyboard and mouse input from a second hand to manipulate the digital document space. This two-handed interaction further integrates paper and computers as a closely coupled interactive space.

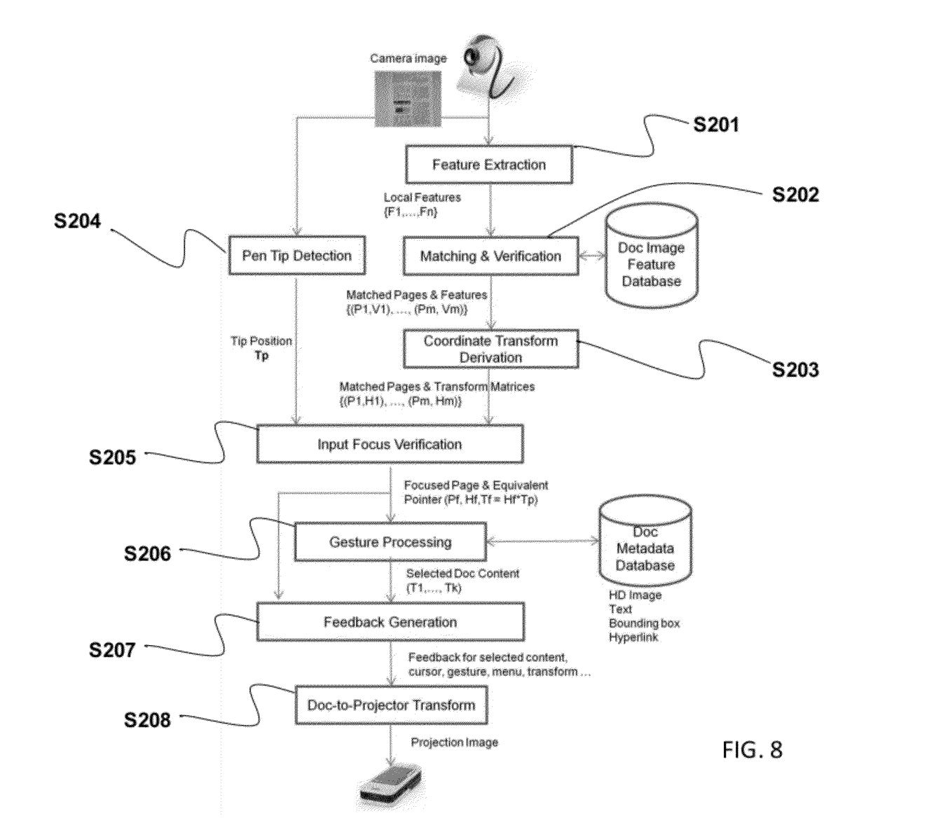

FIG. 8 presents one embodiment of an overview of the data flow for a method of fine-grained interaction on paper. In a first step S201, a camera image is submitted to the image feature extractor to obtain a set of local visual features {F₁, . . . , Fₙ}. In step 202, these features are matched against to those in a document image feature database. The m document pages {P₁, . . . , Pₘ} with enough matched features {Vᵢ: the set of matched features for page i, i=1 . . . m} above a threshold are taken as the original digital pages for the physical ones in the camera image. Based on the feature point correspondence, the system, in step S203 then derives a homographic transform Hⱼ from the camera image to the matched digital page J, J=1 . . . m. The pen tip position is detected in step S204. In step S205, this transform information is combined with the detected pen tip position Tₚ in the camera image to determine the specific focused document page P_{f} to which the pen tip is pointing. Then the pen pointing is interpreted as the equivalent mouse pointing at the position T_{f}=H_{f}*Tₚ in digital page P_{f}. In the subsequent gesture processing in step S206, like a pen-based computer, the system accumulates the point samples as a gesture stroke, and accordingly selects the specific document content {T₁, . . . , Tₖ} from a metadata database, which stores, for each registered document page, the high resolution version, text, bounding boxes of words and symbols, hyperlinks and so on. In the meantime, in step S207, the system generates feedback information to indicate the current cursor, focused page, transform accuracy, gesture and selected document content, which, in step S208, is then converted into a projection image to overlay the visual feedback on paper.

In one embodiment, the system 100 maps the pen tip input 142 from paper 112 to the corresponding digital document 138 and projects the visual feedback 146 onto paper. With this mechanism, the paper documents and physical document workspace are treated like a touch-sensitive display, so that conventional pen or stylus-type computer operations are extended to the physical document.

In one embodiment, the pen input may be interpreted as either free-form handwriting or command gestures, depending on whether the current input mode is “ink” or “gesture,” respectively. In “ink” mode, the input is recorded as written annotations, which can be stored on a corresponding digital document and retrieved later for review, or shared with remote co-workers viewing the digital document over a network. If an actual inking pen is used, the ink left on the paper usually provides higher fidelity than the digital version, so in an alternate embodiment, ink lifting techniques may be adopted to extract the ink annotations from paper. In “gesture” mode, the pen input is used to construct computer commands, which consist of one or more document segments as target sections for the command and a desired action to be carried out on the document segment. Users may draw pen strokes on the physical document to select individual words, characters, symbols, images, icons and arbitrary regions or shapes for various functions.

### Selecting Command Targets

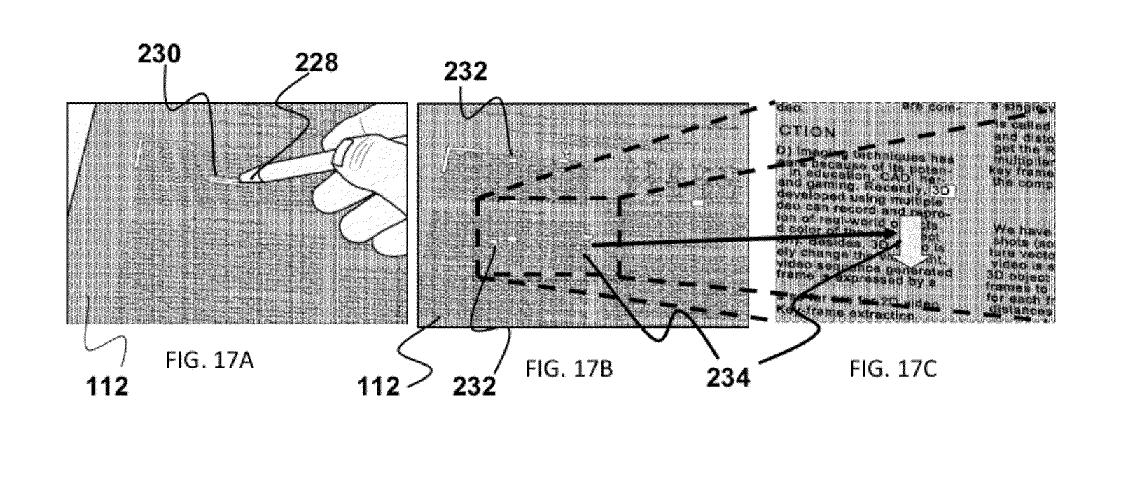

Like a normal pen-based interface, there are two basic statuses of the input, namely “hover” and “touch.” According to one embodiment, in “hover” status, the pen is above paper without touching the surface. The user can move the pen to direct a projected cursor to the intended word. At any time, the word closest to the pointer 142 is highlighted 146 by the projector feedback, as shown in FIG. 17A. In one embodiment, the input mode changes to “touch” status upon the pen touching the surface of the physical document, and the resulting pen input is interpreted as a gesture to select document content for further action. The gesture ends upon the pen being lifted from the surface.

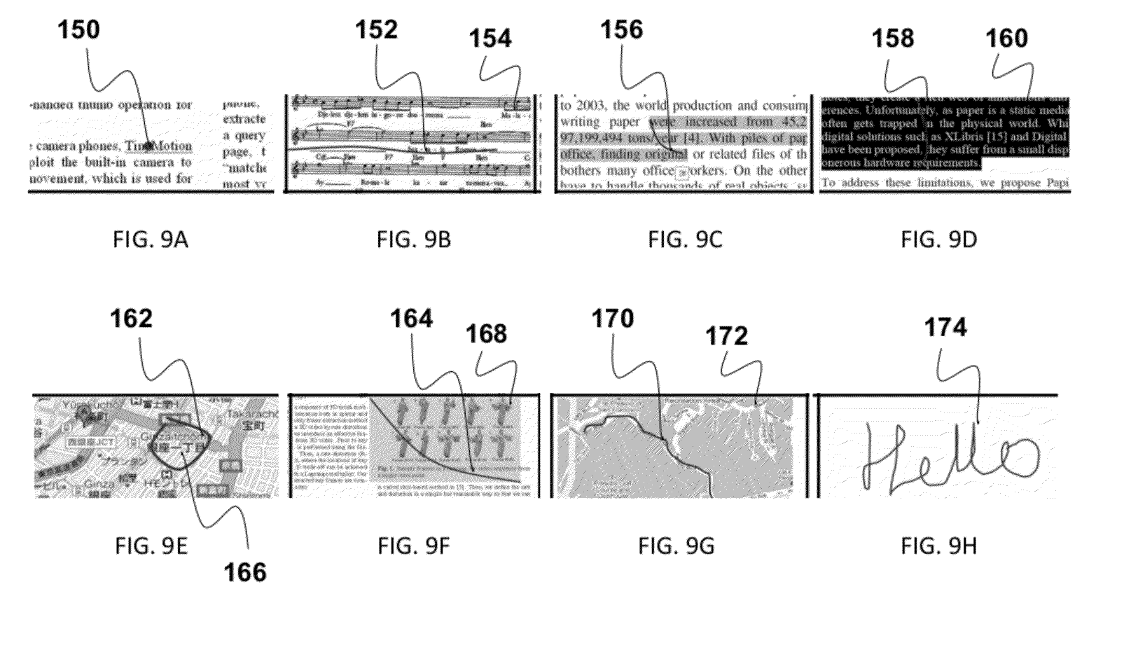

There are many types of gestures for selecting words, symbols and other document content. As illustrated FIG. 9A, “pointer” 150 is suitable for the point-and-click interaction with pre-defined objects (e.g. words, East Asian characters, math symbols and icons); “underline,” 152, as shown in FIG. 9B, is used to select a line of text or bars of music notes 154; “bracket” 156, as shown in FIG. 9C, and “vertical bar” 158, as shown in FIG. 9D, is used for selecting a section of text 160 in a sentence and multiple lines, respectively; “lasso” 162 as shown in FIG. 9E, and “marquee” 164, as shown in FIG. 9F, support selecting an arbitrary document region 166 or 168, respectively; “path” 170, as illustrated in FIG. 9G, can be employed to set a route on a map 172; and “freeform” 174, as shown in FIG. 9H, can be any type of input gesture and can be interpreted in an application-specific way. The gestures and selected document content are highlighted in FIGS. 9A-9H for clarity, but in the system described herein, the gestures are drawn on paper with projected feedback from the projector.

In one embodiment, the system does not support multi-stroke gestures nor perform gesture recognition in order to provide a simpler implementation. However, the system can support these features if desired. In this embodiment, users need to choose a gesture type manually before issuing a gesture.

To implement the above operations, metadata is extracted from each digital document stored in a system database. Such metadata may include the bounding box (position and size) in the document reference frame of words, characters and icons, and their text and associated uniform resource locations (URLs), if any. The metadata is combined with the pen input to set command targets (e.g. the words selected by an underline gesture), and is also used to generate visual feedback on the paper, such as a rectangular white block to highlight the selected words, as shown in FIG. 16B.

### VI. Context-Aware Feedback of Gestures

The projected feedback in response to the gestures is specially designed to limit the possible interference with the original visual features of the paper documents, otherwise the accuracy of the physical-digital interaction mapping could be compromised. First, rendering the gesture strokes is avoided if possible. For example, feedback is only projected for the text selected by the Underline, Bracket, and Vertical gestures, but is not rendered for the raw gesture strokes. Second, thin straight line segments are used for projection (except the lasso and free-from gestures) as much as possible, because they generate fewer feature points than complex patterns. Third, highlighting large areas with solid bright colors is avoided, as the resulting glare may distort the original document's visual features. Lastly, in one embodiment, projected feedback is only placed on the most outer contour 175 of the selected content 177, as illustrated in FIG. 10, instead of highlighting individual sections of the content separately, as with regular computer interfaces. The contour highlighting helps to further reduce the undesired image features.

### Selecting a Command Action

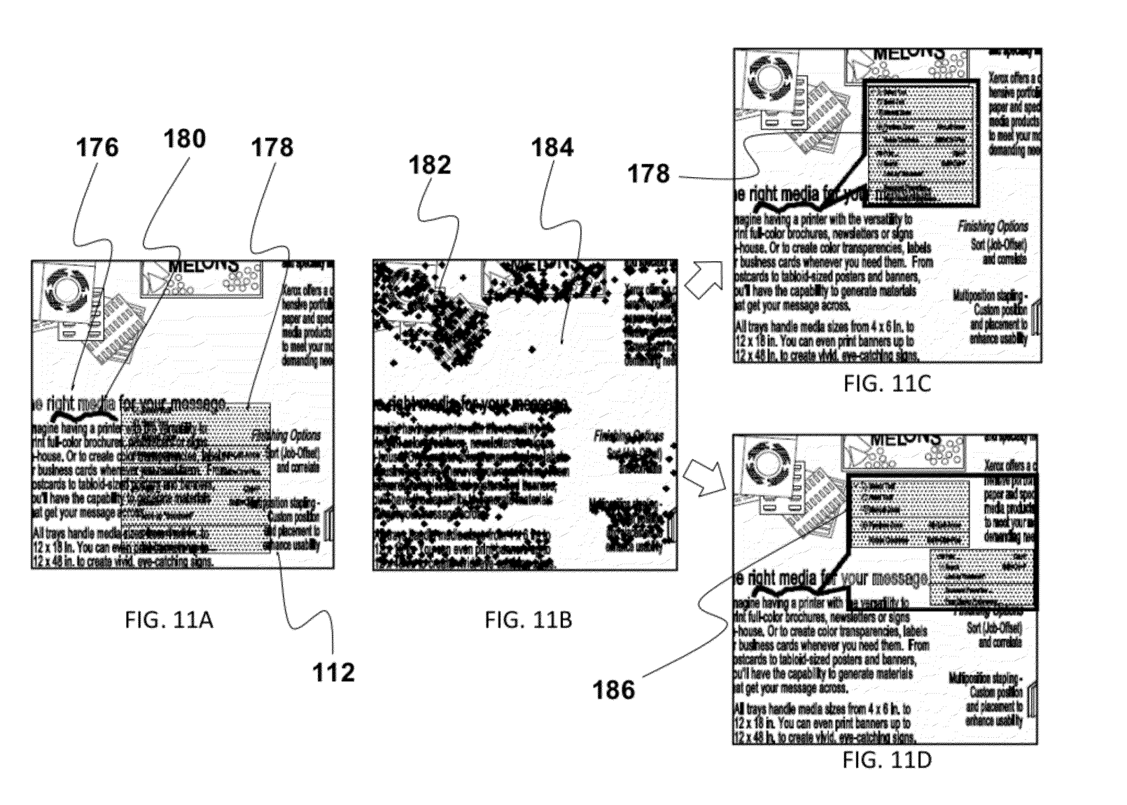

In FIG. 11A, after the command target 176 has been specified, the user needs to select a desired action from a menu 178. This action menu 178 may be directly projected on paper 112, right next to the ending point of the gesture 180, as shown in FIG. 11A. This “in-place” menu 178 saves movement of the pen or finger and makes the command gesture and selection fluid and smooth. However, as illustrated in FIG. 11A, the projected menu 178 may be occluded by the underling text or picture, making it difficult to read the text in the action menu 178. This situation is even worse when the surrounding environment is bright and the projector luminance is limited, which is common in realistic working environments. Although some adaptive radiometric compensation methods have been proposed to adjust the projection image to make the final projection appear almost the same as the original image, these methods do not work well on high-contrast and complex background areas, such as text and maps.

One solution is adaptive placement of the menu, where the embodied system automatically projects the menu 178 in an area with minimum occlusion. In one embodiment, this is implemented by searching for a region with the least texture and shortest distance from the command target within the projection area. Since it is possible that no regions satisfy both criteria, a weighting function is adopted to choose the optimum region. The spatial distribution of the text could be approximated by that of the previously described FIT feature pointers 182 of the camera images, as illustrated by the dots in FIG. 11B, which are a byproduct of document recognition and cost little extra time. An algorithm can be applied to search for an appropriate open region 184 and fit the menu 178 in the region (to the degree that the menu is still legible), as illustrated in FIG. 11C. In one embodiment, the algorithm can be similar to that disclosed in Liu, Q., C. Liao, L. Wilcox, A. Dunnigan, and B. Liew; Embedded Media Markers: Marks on Paper that Signify Associated Media. Proceedings of IUI '10, pp. 149-158. Furthermore, the menu window 178 itself can be modified to best fit the non-occlusion area or areas, as shown by the divided menu 186 in FIG. 11D, as long as the interface consistency is maintained. In one embodiment, an arrow may be projected from the command target to the menu to help users follow the menu.

In a situation where there is no good place for the menu, the command action menu may instead be displayed on the computer screen, which is immune to the occlusion issue. The menu may be rendered at a fixed location on the screen for consistent user experience. Moreover, rendering the menu on the screen does not necessarily increase the eye-focus switching between the paper and the screen, as the user usually needs to turn to the computer screen for the results of the command targets executed on the paper document.

### Handling Recognition Failure

The above-described fine-grained interaction relies on accurate document recognition and coordinate transform. Sometimes, however, the recognition may fail due to bad lighting conditions, paper distortion and non-indexed documents. And the transform matrices may be inaccurate due to insufficient feature point correspondence. To recover from such errors, the computer may be exploited to enhance the paper interaction.

If the paper document recognition fails (i.e. the number of matched feature points is below a threshold), one embodiment of the system allows the user to choose the corresponding digital version from a top-N list, or from the whole database. In case of a non-indexed document which is not present in the database, the user switches the camera to a still image mode, takes a high-resolution photograph of the document, and manually indexes it in the database. The system may also apply optical character recognition (OCR) to the picture to generate text metadata.

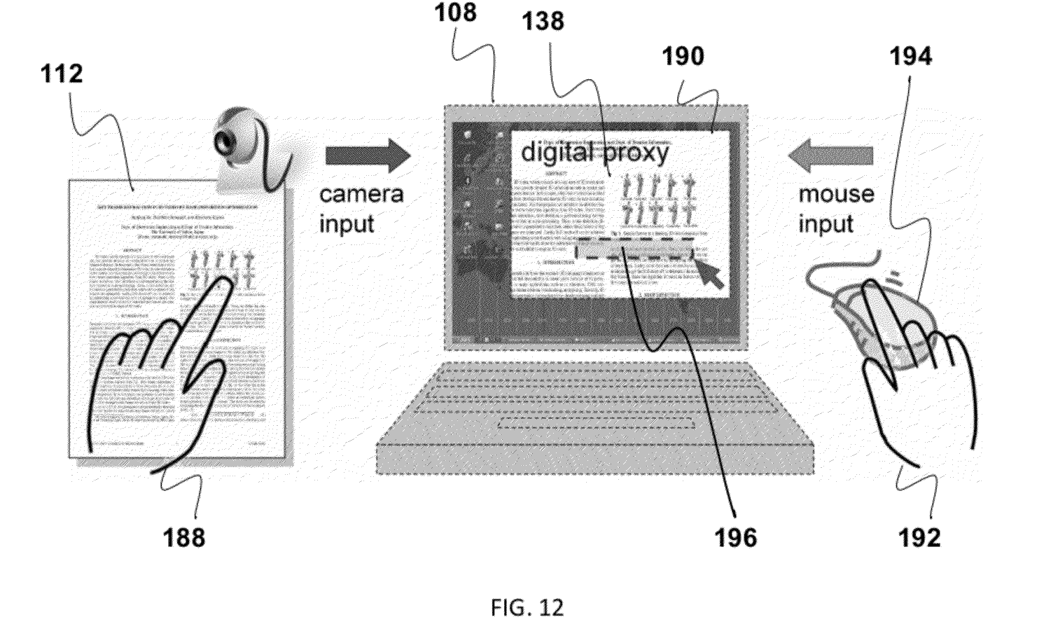

If the corresponding digital version of the physical is found and the accuracy of the transform matrix is not sufficient (based on an estimate of the number of matched feature points), the system resorts to a digital proxy technique, which uses the paper document for initial coarse interaction and the computer for fine interaction. As shown in FIG. 12, once a first hand 188 is present on the paper document 112, the whole corresponding digital document page 138 will be retrieved and rendered in a popup window 190 on the screen 108. The user can then use a second hand 192 to operate a computer input device, such as a mouse 194, to continue manipulating the digital document 138 at fine-granularity, for example by copying a selected area 196 on the page.

The finger or pen gestures described above can also be applied on the computer as well. In one embodiment of a method for applying gestures on the computer (not illustrated), once the finger or pen gesture operation is done, the user moves the first hand out of the camera view. In response, the digital proxy window shrinks to an icon, and the screen restores to the previous status for the next step of the cross-media operation, for example pasting a copied figure into another document file. Since manipulation of the paper document is bypassed, an inaccurate transform Hr is not as significant.

VII. Two-Handed, Simultaneous Interaction with Physical and Digital Documents

As found in previous studies looking at a worker's manipulation of documents, a worker involved in using documents spends almost half of the time working on multiple documents—for referring, comparing, collating, summarizing and so on. In a situation with a portable computer with a limited screen size, paper documents are often used to extend the screen for multi-document interaction. This interaction, however, is more complicated than normal multi-window operations on a screen, as the documents may reside in different media and involve different input methods. For example, a user may want to copy a figure from paper to the computer, associate a web page with a word on paper, or navigate a street view map on a computer to find a place on a paper map. The input devices for paper are mainly a finger or a pen, and for the computer, a keyboard and a mouse. For these cross-media multiple document operations, one-handed interaction requires the user to switch input devices and sometimes to change body pose, which is inconvenient.

Therefore, one embodiment of the invention supports cross-media two-handed interaction, so that users can use one hand to carry out operations on paper and the other hand to carry out operations on the computer. The two input streams, from the camera and computer, are coordinated to support multiple-document manipulation.

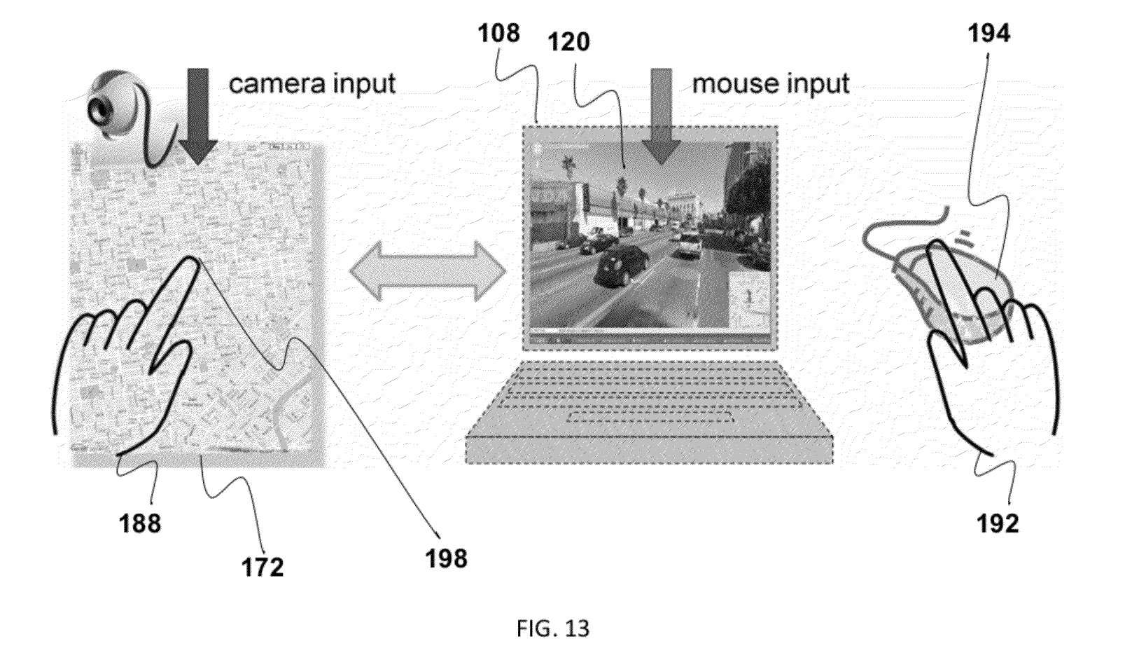

In one embodiment of a method for cross-media interaction, the cross-media two-handed interaction can be used to support information transfer. For instance, to get information on an unfamiliar Japanese word, “ [symbol] ” appearing on a paper document, the user may point her first hand to the characters or word, and then use her second hand to choose a command on the computer, such as “search the web.” In response, the system forwards the selected text to the computer, which performs a web search and displays the results to the user. Similarly, the user can easily lasso a picture on the paper document and then copy it into a word processing or other document on the computer. In another embodiment, the information transfer can be in the reverse direction. Multimedia annotations can be projected onto the paper document from the computer. The annotations can be represented by an icon projected on the paper and re-played with a double click. The two hands can also be used to naturally establish information association linking two document segments across the paper-computer boundary. For example, the user can link an encyclopedia or dictionary web page to the Japanese word on the paper, so that selecting the Japanese word on the paper in the future will result in displaying the linked web page on the computer screen. The user can also operate on different views of the same compound document synchronously for multiple-view manipulation. For example, as illustrated in FIG. 13, the user can select a position 198 on a printed map 172 with the first hand 188 to display a street view image 120 of that location on the computer screen 108, then use the second hand 192 to control the mouse 194 and navigate around the corresponding street view display 120 corresponding to the selected map position 198.

### VIII. Two-Handed Hybrid Input for Paper Document Interaction

The two-handed input can be used not only for cross-media operations, but also for single media operations. The system supports augmenting paper operations with the computer input. This is motivated by the complementary affordances of the camera-projector unit and the computer. The camera-based finger input, although natural for paper manipulation, is usually less robust and has a lower input sampling rate than the mouse and keyboard. This causes relatively inferior user experience for paper interaction, especially for fine-grained interaction. The problems with finger or pen input may be magnified when there is only one hand for gesturing on paper (e.g. during two handed cross-media interaction), because, with the other hand providing input to the computer, the friction caused from the finger-paper contact may cause undesired movement of the paper sheets.

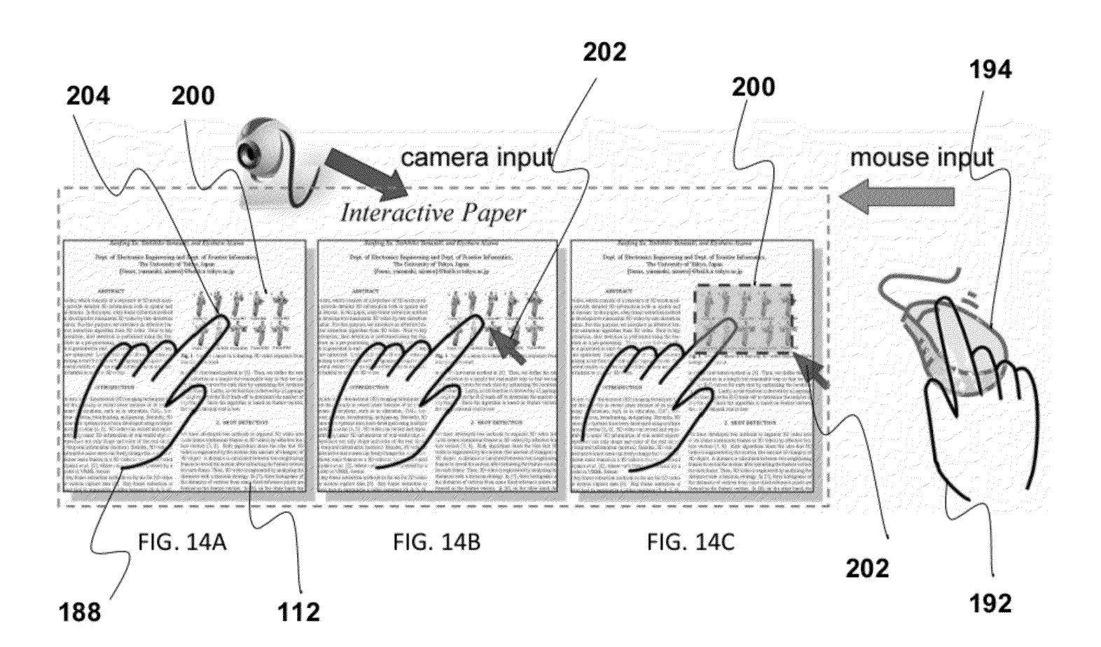

To make the best use of the available affordances of the hybrid system, in one embodiment, the keyboard and mouse input may be re-directed provide input and feedback to the paper document, and combine the input with the camera input for two-stage, progressive, fine-grained interaction. For example, as illustrated in FIGS. 14A-14C, to select a rectangular region 200 in a paper document 112, the user first points a first hand 188 to the region roughly while keeping the second hand 192 on the mouse 194, as shown in FIG. 14A. In FIG. 14B, upon detecting the presence of the first hand 188 in the camera view, the system moves the mouse cursor 202 to where the finger tip 204 is located on the paper document 112, as the mouse cursor 202 is being projected onto the paper document 112. From this initial coarse selection, the user operates the mouse 194 to click and drag the mouse over the rectangular region 200 and refine the selected region 200 with higher fidelity, as illustrated in FIG. 14C. The first hand 188 can just rest on the paper document 112, avoiding unintended movement of the paper.

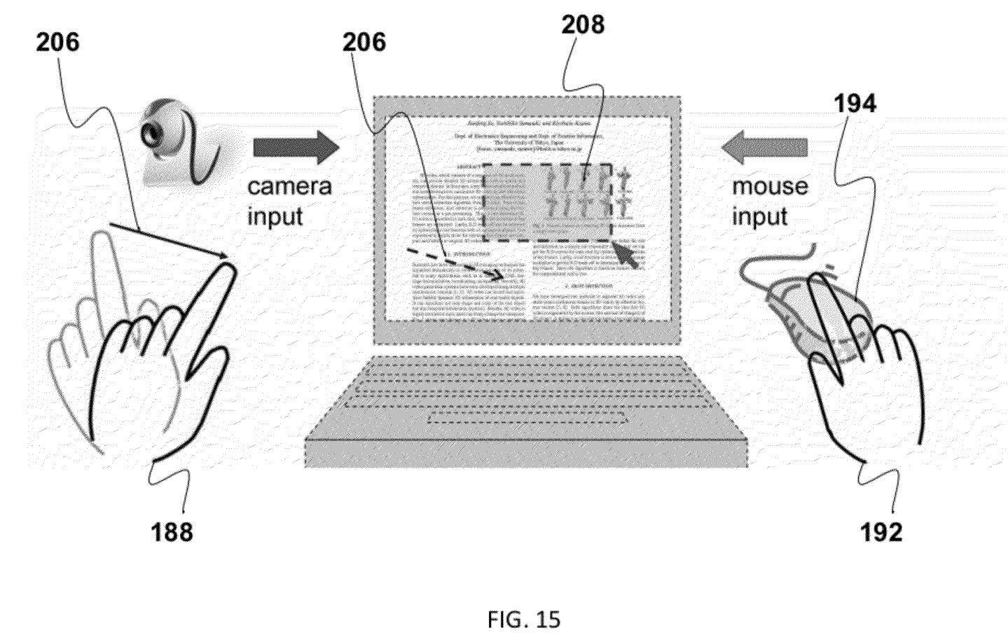

A computer keyboard (not shown) can be also used to add high fidelity text information to paper documents. For example, the user can select a document segment on paper and then type text annotations for the segment; one can also use a keyboard to correct OCR errors for a selected paper document region. This keyboard input is particularly useful, in one example, for a semi-automatic paper receipt transcription application, as described below with respect to FIG. 15. The system is therefore able to augment interaction with paper documents in addition to augmenting interaction with computer documents.

IX. Two-Handed Interaction with Physical and Digital Documents Simultaneously

A fused camera input and computer input can be also applied to screen-only interaction in an additional embodiment. The system can redirect the pen-based or finger-based pointing on the paper document to the computer in order to control digital documents. The pen-based and finger-based pointing can be combined with the mouse input for multi-pointer interaction on the screen without the need for extra hardware. For example, with a physical document-based pointer and a computer-based pointer, a user can scale and rotate a picture simultaneously. In another example, as illustrated in FIG. 15, the user can pan a document with the first hand 188 flicking 206 on paper and select specific content 208 with a second hand 192 operating a mouse 194. Without the additional finger-based input, the mouse does not have to switch back and forth between the panning and selecting tasks. The aforementioned two-handed interaction is useful for normal computers that otherwise do not support multi-touch interaction.

### X. Applications

The interaction techniques described in the variety of embodiments above can be applied to a number of scenarios for mixed use of paper and computers. Several non-limiting examples include paper receipt processing, document manipulation and map navigation, as will be described in more detail immediately below.

### Receipt Processing

Paper receipts are extensively used for their simplicity, robustness and compatibility with existing paper-based work flows. However, integrating paper receipts into new digital financial document work flows is tedious and time-consuming. Much research and various commercial products have been developed in this area. However, many of them require fully manual transcription of information from the receipt, such as expense amounts and dates. Others apply OCR to automatically extract the information from receipts, but lack of a convenient error correction interface and other limitations makes accountants' verification difficult.

In one embodiment of a method of receipt processing, the system described above is capable of processing receipts, as illustrated in FIGS. 16A-16F. Once a receipt 210 is put in the camera view in FIG. 16A, the system first tries to recognize it by finding an identical digital version in an existing receipts database of previously detected receipts. If no matching digital version is found, the receipt 210 is treated as new and the user may be notified with a projected message 212, as shown in FIG. 16B. The system then takes a high-resolution picture 214 of the receipt, which is displayed on the computer screen 108 in FIG. 16C. The picture 214 is then stored in the system database. One issue of the paper receipt processing is that receipts may not have sufficient feature points for accurate coordinate transform, as they typically have less content than normal documents. In that case, the digital-proxy strategy described above may be used to allow the user to manipulate the receipt 210 on the screen 108 with similar gestures and correction mechanism. For example, in FIG. 16D, a user can draw an underline gesture (not shown) directly on the receipt picture 214 on the screen 108 to select a specific region 216 for OCR, in this case, a date. In one embodiment, the OCR result 218 is displayed next to the region 216 for verification. If the OCR result 218 is incorrect, the user can use a keyboard (not shown) to modify it. In addition, as shown in FIG. 16E, the receipts processing application includes a data entry software application 220 with cells 222 in which to enter information from the receipt. In this embodiment, each transcribed cell value in the software application 220 can be linked to the relevant section 224 of the receipt picture 214 where the information was derived, so that the user can easily verify the information in each cell 222 by selecting the cell, which retrieves the picture 214 of the receipt 210 with the relevant section 224 of the receipt highlighted 226, as illustrated in FIG. 16F.

### Document Manipulation

As demonstrated above, the system helps users perform many fine-grained document operations on paper. Keyword finding, copy-paste, and Internet searching are three non-limiting examples. In one embodiment of a keyword finding application, illustrated in FIG. 17A, the user can use the pen tip 228 to select a word 230 in the paper document 112, or type any word using the keyboard (not shown) to find its occurrences 232 through the document, as shown in FIG. 17B. The system performs a full-text search of the document and precisely highlights the occurrences 232 via the projector (not shown). In one embodiment, some of the occurrences 232 may be out of the projection area. Therefore, the projector may display arrows 234 around the projection borders to indicate more occurrences in a particular direction, as shown in FIG. 17C. The user can then move the document 112 in the direction indicated by the arrow 234 to reveal additional occurrences 232 in the document.

### Map Navigation

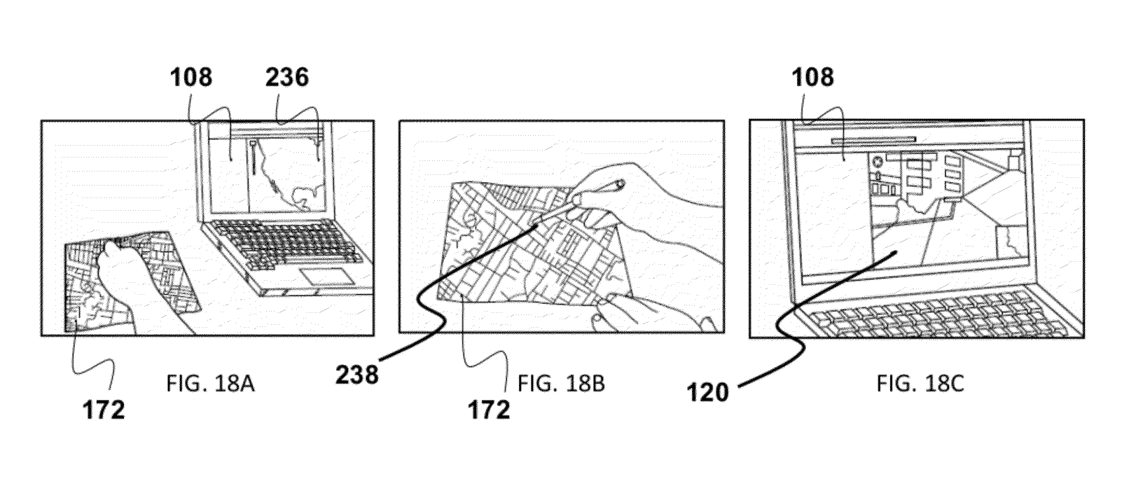

Paper maps provide large, robust, high quality displays, but they lack dynamic information available on a digital map, such as street view images and dynamic traffic information. In one embodiment of the system, illustrated in FIG. 18A, interactions with a paper map 172 can be integrated with a digital map 236 on a computer screen 108. As shown in FIG. 18B, any specific point 238 or route can be selected on the paper map 172, and the system processes the user's selection and navigates a corresponding street view image 120 on the screen 108 to the selected point 238 or route, as shown in FIG. 18C. In another embodiment, the user can manipulate the street view map application to “drive” down a street, and this movement can be highlighted by the projector on the paper map.

### XI. Computer Embodiment

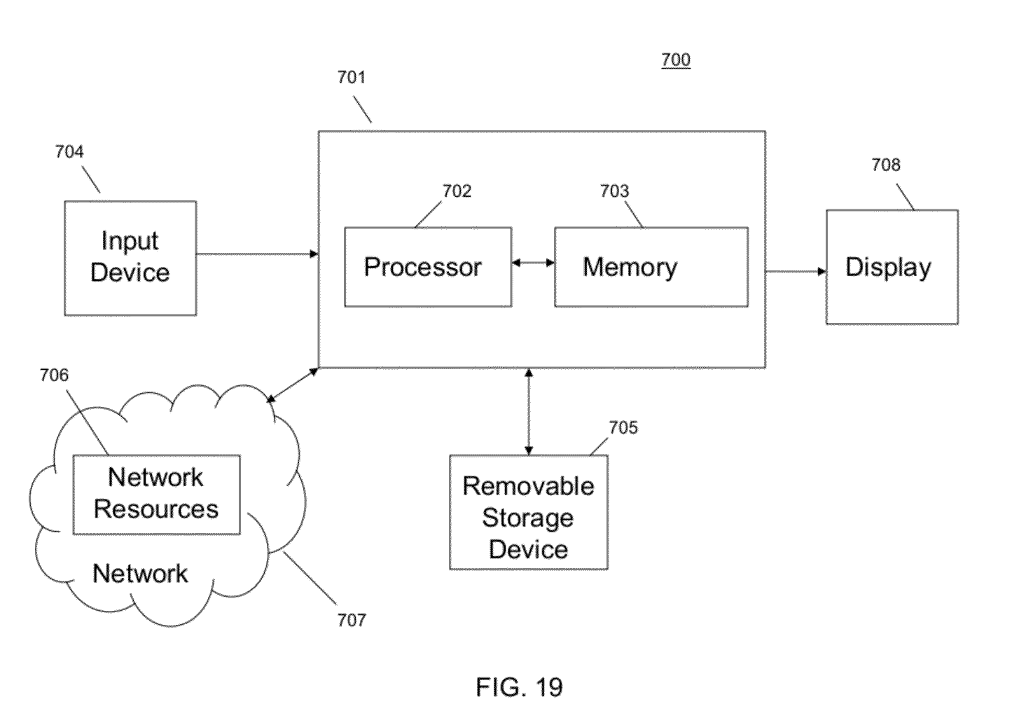

FIG. 19 is a block diagram that illustrates an embodiment of a computer/server system 700 upon which an embodiment of the inventive methodology may be implemented. The system 700 includes a computer/server platform 701 including a processor 702 and memory 703 which operate to execute instructions, as known to one of skill in the art. The term “computer-readable storage medium” as used herein refers to any tangible medium, such as a disk or semiconductor memory, that participates in providing instructions to processor 702 for execution. Additionally, the computer platform 701 receives input from a plurality of input devices 704, such as a keyboard, mouse, touch device or verbal command. The computer platform 701 may additionally be connected to a removable storage device 705, such as a portable hard drive, optical media (CD or DVD), disk media or any other tangible medium from which a computer can read executable code. The computer platform may further be connected to network resources 706 which connect to the Internet or other components of a local public or private network. The network resources 706 may provide instructions and data to the computer platform from a remote location on a network 707. The connections to the network resources 706 may be via wireless protocols, such as the 802.11 standards, Bluetooth® or cellular protocols, or via physical transmission media, such as cables or fiber optics. The network resources may include storage devices for storing data and executable instructions at a location separate from the computer platform 701. The computer interacts with a display 708 to output data and other information to a user, as well as to request additional instructions and input from the user. The display 708 may therefore further act as an input device 704 for interacting with a user.

What is claimed is:

1. A system for interacting with physical documents and at least one computer, comprising:
a camera processing module which processes the content of at least one physical document and detects user interactions on the at least one physical document;
a projector processing module which provides visual feedback on the at least one physical document; and
a computer with a screen which coordinates the user interactions on the at least one physical document with an action on the computer.

2. The system of claim 1, wherein the camera processing module processes fine-grained content of the at least one physical document, including individual words, characters and graphics, and wherein the camera processing module detects user interactions relating to the fine-grained content.

3. The system of claim 1, wherein the visual feedback provided by the projector processing module is based on user interactions on the physical document.

4. The system of claim 1, wherein the user interactions further include gestures made on the at least one physical document which correspond to actions on the computer.

5. The system of claim 4, wherein the gestures correspond to pre-configured commands which result in a specific type of visual feedback.

6. The system of claim 1, wherein a user interaction on the computer is translated into visual feedback provided by the projector to the at least one physical document.

7. The system of claim 1, wherein the projector processing module provides visual feedback on a physical surface other than the physical document.

8. The system of claim 1, further comprising a portable, integrated camera and projector with a foldable frame and at least one mirror, the mirror attached to the frame and positioned over the at least one physical document to reflect an optical path of the camera and projector onto the at least one physical document.

9. The system of claim 1, wherein the camera processing module processes the content of the at least one physical document and obtains a corresponding digital document to display on the computer screen.

10. The system of claim 9, wherein the user interactions on the at least one physical document result in corresponding interactions on the corresponding digital document.

11. The system of claim 1, wherein the camera processing module processes the content of the at least one physical document and obtains digital content which relates to the at least one physical document.

12. A method for interacting with at least one physical document and at least one computer, comprising:
processing the at least one physical document;
detecting user interactions with the at least one physical document;
providing visual feedback on the at least one physical document; and
coordinating the user interactions on the at least one physical document with interactions on a computer with a screen.

13. The method of claim 12, further comprising:
processing the at least one physical document to identify fine-grained content, including individual words, characters and graphics; and
detecting user interactions relating to the fine-grained content.

14. The method of claim 12, wherein the visual feedback is based on user interactions on the physical document.

15. The method of claim 12, wherein the user interactions further include gestures made on the at least one physical document which correspond to actions on the computer.

16. The method of claim 15, wherein the gestures correspond to pre-configured commands which result in a specific type of visual feedback.

17. The method of claim 12, further comprising providing visual feedback on a physical surface other than the physical document.

18. The method of claim 12, further comprising translating a user interaction on the computer into visual feedback on the at least one physical document.

19. The method of claim 18, further comprising translating user interaction with the at least one physical document with simultaneous user interaction on the computer to manipulate detailed content of the at least one physical document.

20. The method of claim 12, wherein detailed content of the physical document is manipulated by user interactions using a first hand to interact with the at least one physical document and a second hand to interact with the computer.

21. The method of claim 12, wherein detailed content of the digital document is manipulated by user interactions using a first hand to interact with the at least one physical document and a second hand to interact with the computer.

22. The method of claim 12, further comprising synchronously manipulating detailed content of the physical document and a digital document on the computer using a first hand to interact with the at least one physical document and a second hand to interact with the digital document.

23. The method of claim 12, further comprising processing the content of the at least one physical document and obtaining a corresponding digital document to display on the computer screen.

24. The method of claim 23, wherein the user interactions on the at least one physical document result in corresponding interactions on the corresponding digital document.

25. The method of claim 12, further comprising processing the content of the at least one physical document and obtaining digital content which relates to the at least one physical document.

26. A computer program product for interacting with at least one physical document and a computer, the computer program product embodied on a computer readable storage medium and when executed by a computer, performs the method comprising:
processing the at least one physical document;
detecting user interactions with the at least one physical document;
providing visual feedback on the at least one physical document; and
coordinating the user interactions on the at least one physical document with interactions on a computer with a screen.
